(19) United States
(12) Patent Application Publication
(10) Pub. No.: US 2026/0108892 A1
(43) Pub. Date: Apr. 23, 2026

(54) GAS JETTING STRUCTURE, SURFACE TREATMENT METHOD, AND SURFACE TREATMENT DEVICE

(71) Applicant: MEIDEN NANOPROCESS INNOVATIONS, INC., Shinagawa-ku, Tokyo (JP)

(72) Inventors: Tatsunori SHINO, Sodegaura-shi, Chiba (JP); Tetsuya NISHIGUCHI, Bunkyo-ku, Tokyo (JP); Hsuhsiao SUN, Atsugi-shi, Kanagawa (JP)

(73) Assignee: MEIDEN NANOPROCESS INNOVATIONS, INC., Shinagawa-ku, Tokyo (JP)

(21) Appl. No.: 19/486,886

(22) PCT Filed: Feb. 16, 2024
(86) PCT No.: PCT/JP2024/005605

§ 371 Date: Nov. 21, 2025

(30) Foreign Application Priority Data
May 22, 2023 (JP) 2023-083593

(51) Int. Cl. B05B 1/00; B05B 1/02; B05B 1/30

(52) U.S. Cl. CPC B05B 1/005; B05B 1/02; B05B 1/3006

(57) ABSTRACT

A gas jetting structure includes first gas jetting pipes each of which is formed with first gas jetting holes for jetting ozone gas to a substrate, and second gas jetting pipes each of which is formed with second gas jetting holes for jetting unsaturated hydrocarbon gas to the substrate. The first gas jetting pipes and the second gas jetting pipes are arranged horizontally and alternately with each other such that gas flows in the first gas jetting pipes are opposite in direction to gas flows in the second gas jetting pipes.

### TECHNICAL FIELD

The present invention relates to a gas jetting structure, a surface treatment method, and a surface treatment device in which ozone gas and unsaturated hydrocarbon gas are jetted for making a substrate hydrophilic, joining substrates together, resist ashing, removing organic contaminants, etc.

### BACKGROUND ART

A patent document 1 proposes a technique of surface treatment with low-temperature chemical vapor deposition, which uses active species generated from a reaction between high-concentration ozone and unsaturated hydrocarbons. This surface treatment is carried out by a film-forming device that is configured to include a buffer space between a gas inlet section and a shower head structure for uniform film formation.

### PRIOR ART DOCUMENT(S)

### Patent Document(s)

Patent Document 1: Japanese U.S. Pat. No. 6,702,514

### SUMMARY OF INVENTION

In the film-forming device disclosed in patent document 1, the buffer space for the ozone gas and the unsaturated hydrocarbon gas is spread throughout the entire device. With this configuration, it may be possible to produce a uniform distribution, but it is difficult to precisely control distribution of applied radicals by flow rate ratio control.

In view of the foregoing, it is an object of the present invention to provide a gas jetting structure, a surface treatment method, and a surface treatment device, which are capable of precisely controlling distribution of applied radicals by controlling a ratio in flow rate between ozone gas and unsaturated hydrocarbon gas.

According to one aspect of the present invention, a gas jetting structure includes: first gas jetting pipes each of which is formed with first gas jetting holes for jetting ozone gas to a substrate; and second gas jetting pipes each of which is formed with second gas jetting holes for jetting unsaturated hydrocarbon gas to the substrate; wherein the first gas jetting pipes and the second gas jetting pipes are arranged horizontally and alternately with each other such that gas flows in the first gas jetting pipes are opposite in direction to gas flows in the second gas jetting pipes.

According to one aspect of the present invention, the gas jetting structure includes: a first gas buffer pipe structured to receive introduction of the ozone gas and supply the ozone gas to each of the first gas jetting pipes; and a second gas buffer pipe structured to receive introduction of the unsaturated hydrocarbon gas and supply the unsaturated hydrocarbon gas to each of the second gas jetting pipes; wherein the first gas jetting pipes are arranged perpendicular to a longitudinal direction of the first gas buffer pipe; and wherein the second gas jetting pipes are arranged perpendicular to a longitudinal direction of the second gas buffer pipe.

According to one aspect of the present invention, the gas jetting structure is configured such that: the first gas buffer pipe is structured to be switched to receive introduction of the unsaturated hydrocarbon gas in place of the ozone gas; and the second gas buffer pipe is structured to be switched to receive introduction of the ozone gas in place of the unsaturated hydrocarbon gas.

According to one aspect of the present invention, the gas jetting structure includes: a first gas jetting pipe structured to jet ozone gas to a substrate; second gas jetting pipes each of which is formed with second gas jetting holes for jetting unsaturated hydrocarbon gas to the substrate; and a second gas buffer pipe structured to receive introduction of the unsaturated hydrocarbon gas and supply the unsaturated hydrocarbon gas to each of the second gas jetting pipes; wherein the second gas jetting pipes are arranged perpendicular to a longitudinal direction of the second gas buffer pipe.

According to one aspect of the present invention, the gas jetting structure is configured such that: two adjacent ones of the first gas jetting pipes and the second gas jetting pipes have an axis-to-axis distance of 5 to 30 mm therebetween; each of the first gas jetting holes and the second gas jetting holes has a diameter of 0.5 to 2 mm; two adjacent ones of the first gas jetting holes have a center-to-center distance of 5 to 30 mm therebetween; and two adjacent ones of the second gas jetting holes have a center-to-center distance of 5 to 30 mm therebetween.

According to one aspect of the present invention, a surface treatment method with the gas jetting structure includes: supplying the ozone gas to the first gas jetting pipes; and after the ozone gas reaches a predetermined flow rate, supplying the unsaturated hydrocarbon gas to the second gas jetting pipes.

According to one aspect of the present invention, the surface treatment method includes increasing a flow rate of the unsaturated hydrocarbon gas in a stepwise manner.

According to one aspect of the present invention, a surface treatment method with the gas jetting structure includes: an operation of causing the first gas jetting pipes to jet the ozone gas from the first gas jetting holes to the substrate at a predetermined flow rate, while causing the second gas jetting pipes to jet the unsaturated hydrocarbon gas from the second gas jetting holes to the substrate at a flow rate that increases over time; and an operation of causing the first gas jetting pipes to receive introduction of the unsaturated hydrocarbon gas from the first gas buffer pipe in place of the ozone gas, and jet the unsaturated hydrocarbon gas from the first gas jetting holes to the substrate at a flow rate that decreases over time, while causing the second gas jetting pipes to receive introduction of the ozone gas from the second gas buffer pipe in place of the unsaturated hydrocarbon gas, and jet the ozone gas from the second gas jetting holes to the substrate at a predetermined flow rate.

According to one aspect of the present invention, a surface treatment device includes the gas jetting structure.

According to the present invention, it is possible to provide a gas jetting structure, a surface treatment method, and a surface treatment device, which are capable of precisely controlling distribution of applied radicals by controlling a ratio in flow rate between ozone gas and unsaturated hydrocarbon gas.

### BRIEF DESCRIPTION OF DRAWINGS

FIG. 1 is a schematic configuration diagram of a surface treatment device according to first and second embodiments of the present invention.

FIG. 2 is a schematic cross-sectional view showing an internal configuration of a gas treatment furnace in the surface treatment device of FIG. 1.

FIG. 3 is a plan view of an underside of a shower head in the gas treatment furnace of FIG. 2.

FIG. 4 is a time chart of valves operation and gas flow rates according to the first embodiment.

FIG. 5 is a time chart of valves operation and gas flow rates according to the second embodiment.

FIG. 6 is a graph showing quantity distribution of radicals generated according to the first embodiment.

FIG. 7 is a graph showing quantity distribution of radicals generated according to the second embodiment.

FIG. 8 is a schematic configuration diagram of a surface treatment device according to a third embodiment of the present invention.

FIG. 9 is a time chart of valves operation and gas flow rates according to the third embodiment.

FIG. 10 is a schematic cross-sectional view showing an internal configuration of a gas treatment furnace according to a fourth embodiment of the present invention.

FIG. 11 is a plan view of an underside of a shower head in the gas treatment furnace of FIG. 10.

### MODE(S) FOR CARRYING OUT INVENTION

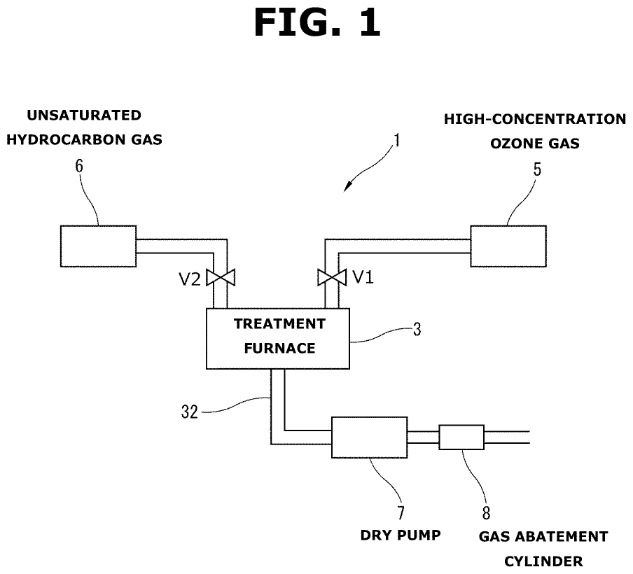

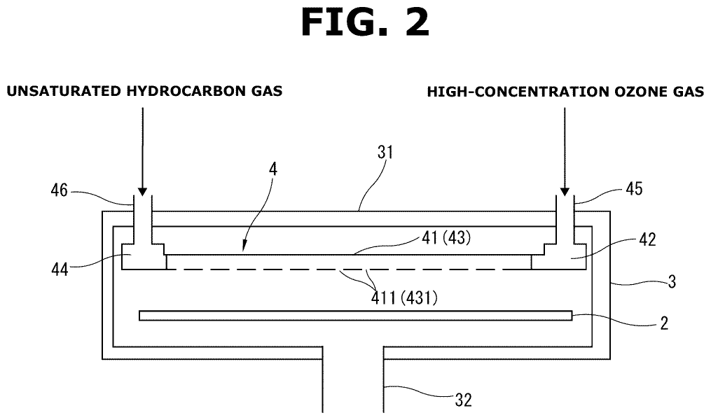

The following describes embodiments of the present invention with reference to the drawings.

[First Embodiment] FIG. 1 shows a surface treatment device 1 according to a first embodiment of the present invention, which includes a treatment furnace 3 that stores a substrate 2 shown in FIG. 2, and a shower head 4 that jets ozone gas and unsaturated hydrocarbon gas to the substrate 2.

The shower head 4 is a gas jetting structure according to one embodiment of the present invention. As shown in FIG. 2, the shower head 4 includes a first gas buffer pipe 42 provided with first gas jetting pipes 41, and a second gas buffer pipe 44 provided with second gas jetting pipes 43.

The first gas buffer pipe 42 receives introduction of ozone gas from an ozone gas supply device 5 via a gas introduction pipe 45, and supplies the ozone gas to each of the first gas jetting pipes 41. The first gas jetting pipes 41 are attached to the first gas buffer pipe 42, and arranged perpendicular to a longitudinal direction of the first gas buffer pipe 42. Each first gas jetting pipe 41 is formed with first gas jetting holes 411 arranged in a longitudinal direction of the first gas jetting pipe 41 for jetting the ozone gas to the substrate 2. The gas introduction pipe 45 is equipped with a valve V1 for controlling the flow rate of the ozone gas. For example, the valve V1 is implemented by a known mass flow controller capable of gas flow rate control.

For example, the ozone gas supply device 5 for supplying the ozone gas is implemented by a device disclosed in patent document 1 which generates high-concentration ozone gas. This device liquefies and separates only ozone based on a difference in vapor pressure between ozone and other gases (for example, oxygen), thereby producing high-concentration ozone gas with an ozone concentration of approximately 100 vol %. For example, this device for generating high-concentration ozone gas is implemented by a commercially available device named Pure Ozone Generator (MPOG-HM1A1) manufactured by Meidensha.

The second gas buffer pipe 44 receives introduction of unsaturated hydrocarbon gas from an unsaturated hydrocarbon gas supply device 6 via a gas introduction pipe 46, and supplies the unsaturated hydrocarbon gas to each of the second gas jetting pipes 43. The second gas jetting pipes 43 are arranged perpendicular to a longitudinal direction of the second gas buffer pipe 44. Each second gas jetting pipe 43 is formed with second gas jetting holes 431 arranged in a longitudinal direction of the second gas jetting pipe 43 for jetting the unsaturated hydrocarbon gas to the substrate 2. The gas introduction pipe 46 is equipped with a valve V2 for controlling the flow rate of the unsaturated hydrocarbon gas. For example, the unsaturated hydrocarbon gas supply device 6 is implemented by a gas cylinder filled with unsaturated hydrocarbon gas such as ethylene gas as disclosed in patent document 1. The valve V2 is identical in specifications to the valve V1.

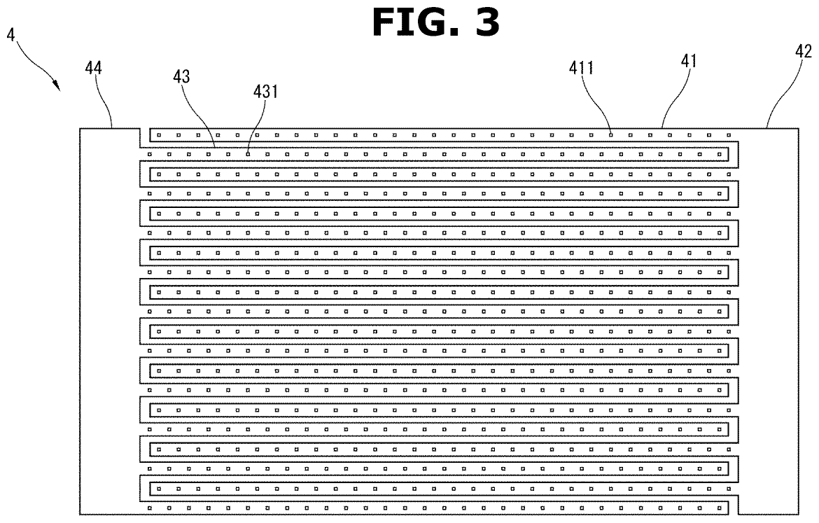

As shown in FIG. 3, the first gas jetting pipes 41 and the second gas jetting pipes 43 are arranged horizontally in the treatment furnace 3 and alternately such that gas flows in the first gas jetting pipes 41 are opposite in direction to gas flows in the second gas jetting pipes 43. In this example, two adjacent ones of the first gas jetting pipes 41 and the second gas jetting pipes 43 have an axis-to-axis distance of 5 to 30 mm therebetween; each of the first gas jetting holes 411 and the second gas jetting holes 431 has a diameter of 0.5 to 2 mm; two adjacent ones of the first gas jetting holes 411 have a center-to-center distance of 5 to 30 mm therebetween; and two adjacent ones of the second gas jetting holes 431 have a center-to-center distance of 5 to 30 mm therebetween.

In the shower head 4 described above, the ozone gas flows through the gas introduction pipe 45, the first gas buffer pipe 42, and the first gas jetting pipes 41. While the ozone gas is flowing through the first gas jetting pipes 41, the ozone gas is supplied from the first gas jetting holes 411 to a surface of the substrate. The unsaturated hydrocarbon gas flows through the gas introduction pipe 46, the second gas buffer pipe 44, and the second gas jetting pipes 43. While the unsaturated hydrocarbon gas is flowing through the second gas jetting pipes 43, the unsaturated hydrocarbon gas is supplied from the second gas jetting holes 431 to the surface of the substrate. In the treatment furnace 3, an exhaust pipe 32 is arranged at the bottom. The treatment furnace 3 is evacuated, wherein, during treatment, pressure is in a range of 1 to 1000 Pa. The location of the substrate 2 in the treatment furnace 3 is adjusted within a region of distribution of the first gas jet holes 411 and the second gas jet holes 431 of the shower head 4 shown in FIG. 2.

The following describes an example of operation according to the first embodiment with reference to FIGS. 1 to 4.

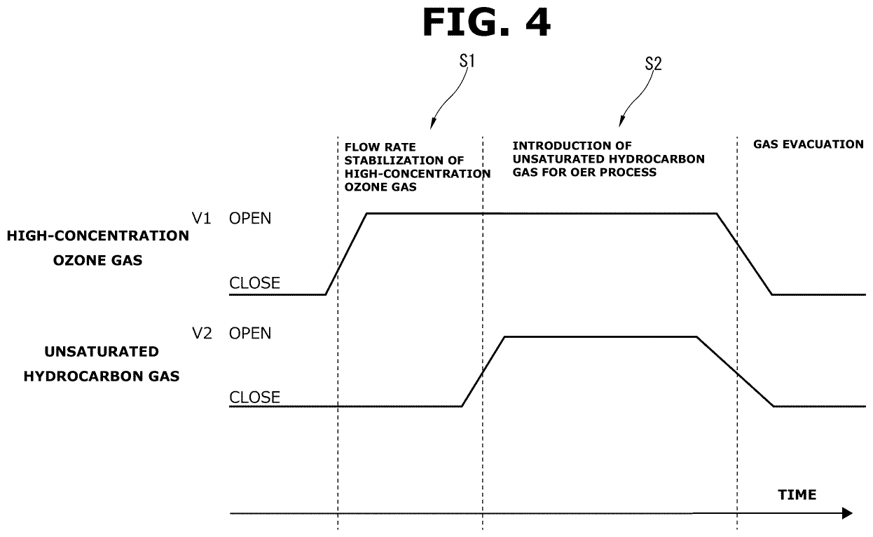

FIG. 4 shows a time chart of valves operation and gas flow rates according to the first embodiment.

First, the valve V1 of the gas introduction pipe 45 shown in FIG. 1 is set opened, and ozone gas is introduced into the first gas jetting pipes 41 via the first gas buffer pipe 42 shown in FIG. 2. When the flow rate of the ozone gas in each first gas jetting pipe 41 is stabilized by an ozone gas flow rate stabilization process (S1), the valve V2 of the gas introduction pipe 46 shown in FIG. 1 is set opened, and a surface treatment process (S2) is initiated.

In the surface treatment process (S2), the unsaturated hydrocarbon gas is introduced into the second gas jetting pipes 43 via the second gas buffer pipe 44 shown in FIG. 2. Then, the surface of the substrate 2 is treated by activated species (for example, OH radicals) generated from combination of the ozone gas from the first gas jetting holes 411 and the unsaturated carbonized gas from the second gas jetting holes 431 as shown in FIGS. 2 and 3. The gas used for the surface treatment is sucked into a dry pump 7 shown in FIG. 1, and flows through the exhaust pipe 32, and is made to undergo a gas abatement process in a gas abatement cylinder 8, and then discharged outside the system. After the surface treatment process (S2) is completed, the valves V1 and V2 are set closed to stop the introduction of the ozone gas and the unsaturated hydrocarbon gas into the shower head 4.

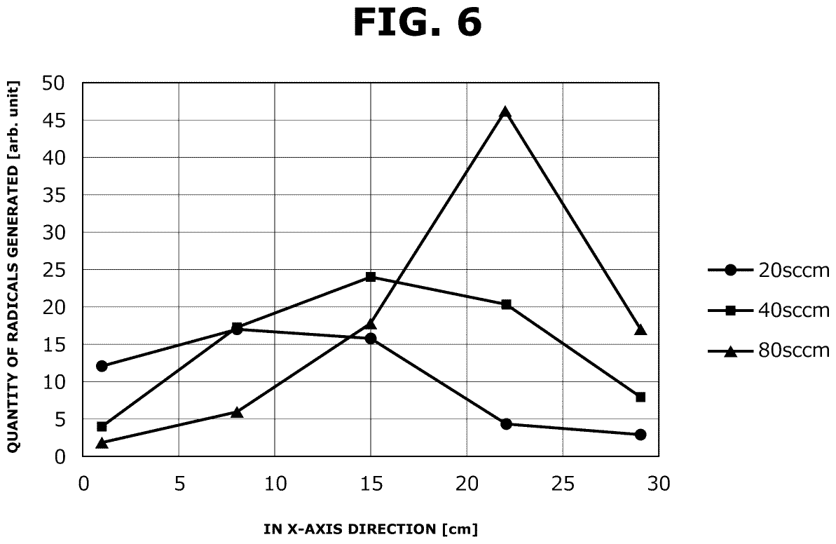

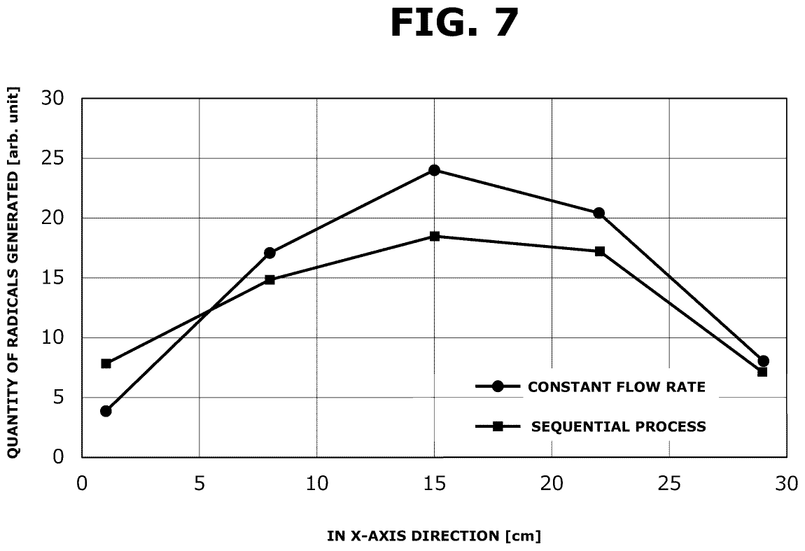

FIG. 6 shows quantity distribution of radicals generated when OER treatment is performed for 60 seconds with the ozone gas flow rate maintained constant at 200 sccm and with ethylene gas as the unsaturated hydrocarbon gas at flow rates of 20 sccm, 40 sccm, and 80 sccm. The distribution was detected by using a quartz crystal microbalance method with frequency changes. In FIG. 6, reference is made to an x-axis that is defined to have its origin at an upstream end one of the second gas jetting holes 431 in the second gas jetting pipe 43 through which ethylene gas flows, and extend on a positive side in the longitudinal direction of the second gas jetting pipe 43 (similar to FIG. 7). As is clear from FIG. 6, the location at which the quantity of radicals generated is maximized shifts as the flow rate of ethylene gas increases. In this way, by controlling the gas flow rate ratio, it is possible to control the quantity distribution of generated radicals in the longitudinal direction of the gas flow path. Furthermore, since the distribution of surface treatment varies depending on the flow rate ratio between the unsaturated hydrocarbon gas and the ozone gas, it is possible to perform localized surface treatment or uniform surface treatment as desired by selecting optimal flow rates in accordance with the distribution of objects to be treated.

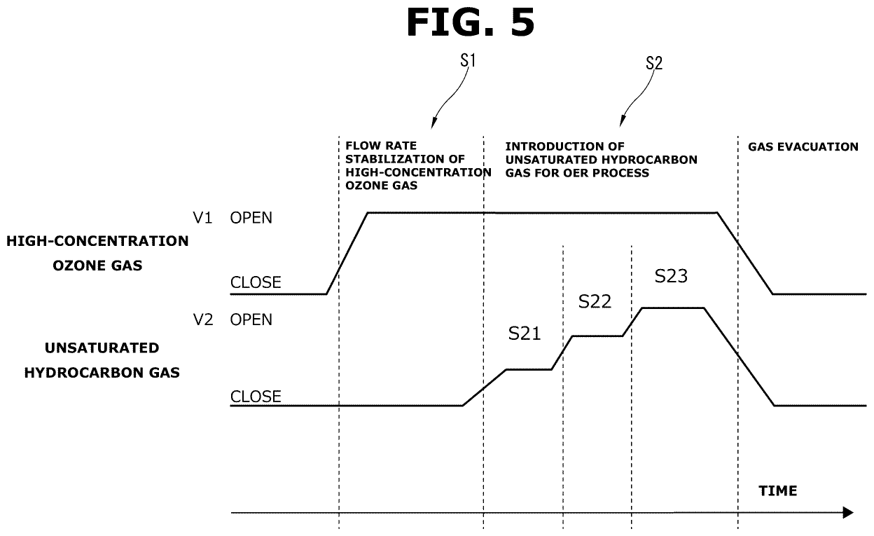

As described above, in the surface treatment device 1 using ozone gas and unsaturated hydrocarbon gas, the first gas jetting pipes 41 and the second gas jetting pipes 43, each of which is formed from a pipe or plate to have gas jetting holes, are arranged alternately with each other in the width direction of the flow paths so that their respective gas flow paths are opposite in direction to each other, thereby making it possible to control the distribution of the amount of treatment in the longitudinal direction of the first gas jetting pipes 41 and the second gas jetting pipes 43 by varying the flow rate ratio between the gases. Furthermore, the provision of the first gas buffer pipe 42 upstream of upstream ends of the first gas jetting pipes 41, and the provision of the second gas buffer pipe 44 upstream of upstream ends of the second gas jetting pipes 43, wherein the first gas buffer pipe 42 and the second gas buffer pipe 44 are buffer spaces for evenly distributing the corresponding gases in the lateral direction of the first gas jetting pipes 41 and the second gas jetting pipes 43, serve to achieve a uniform distribution of the amount of treatment in the width direction of the flow paths.

[Second Embodiment] In the time chart of FIG. 4, the process of introducing the unsaturated hydrocarbon gas at the stage when the flow rate of the ozone gas has stabilized, may be modified such that the flow rate of the unsaturated hydrocarbon gas is increased stepwise as shown in a time chart according to a second embodiment shown in FIG. 5.

The following describes an example of operation according to the second embodiment with reference to FIGS. 1-3 and 5.

FIG. 5 shows a time chart of valves operation and gas flow rates according to the second embodiment in which the flow rate of the unsaturated hydrocarbon gas is changed sequentially.

First, as in the first embodiment, the valve V1 of the gas introduction pipe 45 shown in FIG. 1 is set opened, and ozone gas is introduced into the first gas jetting pipes 41 via the first gas buffer pipe 42 shown in FIG. 2 and jetted to the substrate 2 from the first gas jetting holes 411. When the flow rate of the ozone gas in each first gas jetting pipe 41 is stabilized by the ozone gas flow rate stabilization process (S1), the surface treatment process (S2) is initiated.

In the surface treatment process (S2), the valve V2 of the gas introduction pipe 46 shown in FIG. 1 is set opened, and the unsaturated hydrocarbon gas is introduced into the second gas jetting pipes 43 via the second gas buffer pipe 44 shown in FIG. 2 and jetted to the substrate 2 from the second gas jetting holes 431. During this process, the flow rate of the unsaturated hydrocarbon gas is adjusted by the valve V2 to increase stepwise as shown in steps S21, S22, and S23 shown in FIG. 5. After the OER treatment process (S2) is completed, the valves V1 and V2 are set closed to stop the introduction of the ozone gas and the unsaturated hydrocarbon gas into the shower head 4.

FIG. 7 shows quantity distribution of generated radicals according to the second embodiment, in particular, when OER treatment is performed using ethylene gas as the unsaturated hydrocarbon gas for a total treatment time of 60 seconds, which consists of 31 seconds in step S31 at a flow rate of 20 sccm, 17 seconds in step S32 at a flow rate of 40 sccm, and 12 seconds in step S33 at a flow rate of 80 sccm. FIG. 7 also shows, as a comparative example, quantity distribution of radicals generated when OER treatment is carried out for 60 seconds with constant flow rates of ozone gas and ethylene gas (ozone gas at 200 sccm and ethylene gas at 40 sccm). As is clear from FIG. 7, the sequential process according to the second embodiment improves the quantity distribution of generated radicals as compared to the comparative example in which the flow rates of ozone gas and ethylene gas are constant. This shows that the process of sequentially changing the flow rate ratio of ozone gas to unsaturated hydrocarbon gas enables precise control of the distribution of surface treatment.

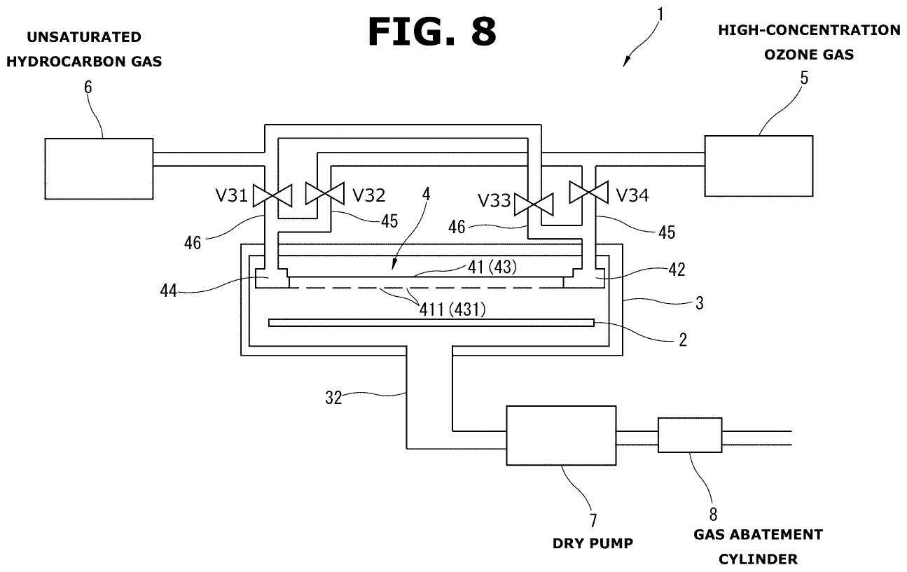

According to the second embodiment, the flow rate ratio between the ozone gas and the unsaturated hydrocarbon gas is changed sequentially, and in particular, the flow rate of the unsaturated hydrocarbon gas is changed in stages, thereby achieving the advantageous effects of the first embodiment and also enabling more precise control of the distribution of the amount of radicals treatment in the longitudinal direction of the first gas jetting pipes 41 and the second gas jetting pipes 43.

[Third Embodiment] FIG. 8 shows a surface treatment device 1 according to a third embodiment of the present invention, which is equipped with gas switching valves for switching physical introduction ports for ozone gas and unsaturated hydrocarbon gas with time.

As shown in FIG. 6, by selecting an appropriate ratio of the flow rate of the unsaturated hydrocarbon gas with respect to the flow rate of the ozone gas, it is possible to locally maximize the quantity of radicals generated. The location where the quantity of radicals is maximized is on the first gas jetting pipes 41 side for the ozone gas with respect to the center of the gas flows of the unsaturated hydrocarbon gas and the ozone gas.

In view of the foregoing, the third embodiment is configured to employ valves arrangement shown in FIG. 8, and also employ the flow rate control according to the second embodiment, thereby increasing the effect of radicals treatment (=speed of treatment) in a desired area (zone) regardless of the position of the substrate 2 in the treatment furnace 3.

In the third embodiment, the second gas buffer pipe 44 is connected to a gas introduction pipe 46 leading to the unsaturated hydrocarbon gas supply device 6, and is also connected to a gas introduction pipe 45 leading to the ozone gas supply device 5. Furthermore, the gas introduction pipe 46 is provided with a valve V31, and the gas introduction pipe 45 is provided with a valve V32.

On the other hand, the first gas buffer pipe 42 is connected to a gas introduction pipe 46 leading to the unsaturated hydrocarbon gas supply device 6, and is also connected to a gas introduction pipe 45 leading to the ozone gas supply device 5. Furthermore, the gas introduction pipe 46 is provided with a valve V33, and the gas introduction pipe 45 is provided with a valve V34. The valves V31 to V34 are also identical in specifications to the valve V1 according to the first embodiment.

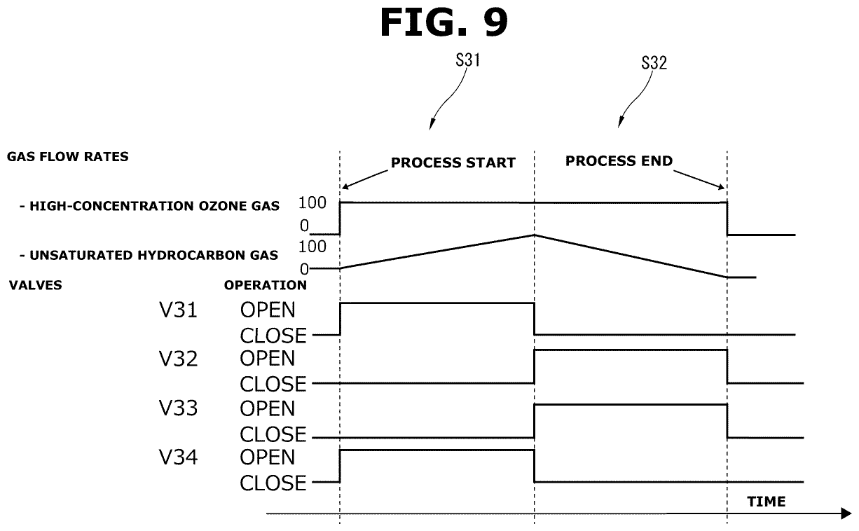

The following describes an example of operation according to the third embodiment with reference to FIGS. 8 and 9.

A first surface treatment process (S31) is started with the valves V31 and V34 set opened, and the valves V32 and V33 set closed. The ozone gas from the ozone gas supply device 5 is introduced into the first gas jetting pipes 41 via the first gas buffer pipe 42 at a predetermined flow rate with the opening of the valve V34 adjusted to 100%, and is supplied to the substrate 2 from the first gas jetting holes 411. The unsaturated hydrocarbon gas from the unsaturated hydrocarbon gas supply device 6 is introduced into the second gas jetting pipes 43 via the second gas buffer pipe 44 at a flow rate that is set to increase over time by adjusting the opening of the valve V31, and is supplied to the substrate 2 from the second gas jetting holes 431.

After a predetermined time has elapsed, a second surface treatment process (S32) is performed with the valves V32 and V33 set opened, and the valves V31 and V34 set closed. The ozone gas is introduced into the second gas jetting pipes 43 via the second gas buffer pipe 44 at a predetermined flow rate with the opening of the valve V32 adjusted to 100%, and is supplied to the substrate 2 from the second gas jetting holes 431. The unsaturated hydrocarbon gas is introduced into the first gas jetting pipes 41 via the first gas buffer pipe 42 at a flow rate that is set to decrease over time by adjusting the opening of the valve V33, and is supplied to the substrate 2 from the first gas jetting holes 411. After the second surface treatment process (S32) is completed, the valves V31 to V34 are set closed to stop the introduction of the ozone gas and the unsaturated hydrocarbon gas into the shower head 4.

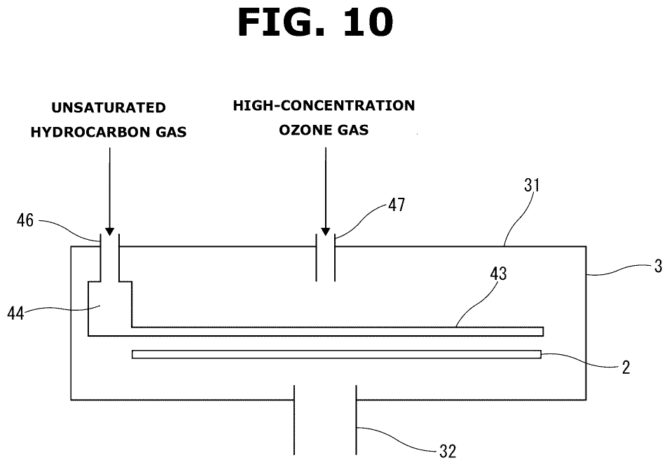

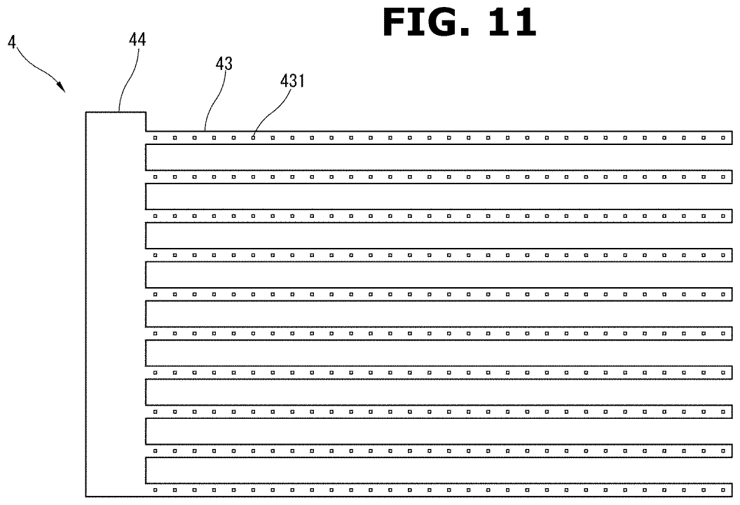

By controlling the gas flow rates over time and operating the valves as described above, the surface of the substrate 2 can be treated uniformly (while preventing a specific portion from being subjected to excessive surface treatment). This enables an etching process with which, for example, when etching is performed using the process according to this embodiment, damage to an underlying layer due to overetching is minimized, and when a semiconductor device (doped layer) is provided on the underlying side, effects on characteristics (characteristic fluctuations) of the semiconductor device are minimized.

[Fourth Embodiment] FIGS. 10 and 11 show a shower head 4 according to a fourth embodiment of the present invention, which has the same structure as the shower head 4 according to the first to third embodiments, except that the shower head 4 according to the fourth embodiment does not include the first gas jetting pipes 41 and the first gas buffer pipe 42. The ozone gas from the ozone gas supply device 5 is introduced into the treatment furnace 3 through a gas jetting pipe 47 arranged concentrically with the substrate 2 above the substrate 2 in the treatment furnace 3 (specifically, in a ceiling portion 31 of the treatment furnace 3). The present embodiment serves for a simplified configuration of the surface treatment device 1, in addition to the advantageous effects of the first embodiment.

The ozone gas is jetted to the substrate 2 from the gas jetting pipe 47 at a predetermined gas flow rate and a predetermined gas pressure. The unsaturated hydrocarbon gas from the unsaturated hydrocarbon gas supply device 6 shown in FIG. 1 is introduced into the second gas jetting pipes 43 via the gas introduction pipe 46 and the second gas buffer pipe 44 shown in FIGS. 10 and 11, and is jetted to the substrate 2 from the second gas jetting holes 431.

The pressure of the ozone gas is preferably 200 Pa or less, more preferably 50 Pa or less. For example, the second gas jetting pipes 43 are configured such that the center-to-center spacing of second gas jetting holes 431 is equal to 10 mm, the distance between second gas jetting holes 431 and substrate 2 is equal to 10 mm, and the treatment pressure is equal to 100 Pa. In this case, the flow velocity of the unsaturated hydrocarbon gas from the second gas jetting holes 431 is equal to about 10 m/sec, the lifetime of radicals is equal to about 1 ms, and accordingly, the distance that the unsaturated hydrocarbon gas can travel is equal to about 10 mm, which satisfy a requirement for radicals to reach the surface of substrate 2 without being deactivated.

1-9. (canceled)

10. A gas jetting structure comprising:
first gas jetting pipes each of which is formed with first gas jetting holes for jetting ozone gas to a substrate; and
second gas jetting pipes each of which is formed with second gas jetting holes for jetting unsaturated hydrocarbon gas to the substrate;
a first gas buffer pipe structured to receive introduction of the ozone gas and supply the ozone gas to each of the first gas jetting pipes; and
a second gas buffer pipe structured to receive introduction of the unsaturated hydrocarbon gas and supply the unsaturated hydrocarbon gas to each of the second gas jetting pipes;
wherein the first gas jetting pipes and the second gas jetting pipes are arranged horizontally and alternately with each other such that gas flows in the first gas jetting pipes are opposite in direction to gas flows in the second gas jetting pipes;
wherein the first gas jetting pipes are arranged perpendicular to a longitudinal direction of the first gas buffer pipe;
wherein the second gas jetting pipes are arranged perpendicular to a longitudinal direction of the second gas buffer pipe;
wherein the first gas buffer pipe includes a buffer space structured to receive introduction of the ozone gas and evenly distribute the ozone gas to each of the first gas jetting pipes; and
wherein the second gas buffer pipe includes a buffer space structured to receive introduction of the unsaturated hydrocarbon gas and evenly distribute the unsaturated hydrocarbon gas to each of the second gas jetting pipes.

11. The gas jetting structure according to claim 10, wherein:
the first gas buffer pipe is structured to be switched to receive introduction of the unsaturated hydrocarbon gas in place of the ozone gas; and
the second gas buffer pipe is structured to be switched to receive introduction of the ozone gas in place of the unsaturated hydrocarbon gas.

12. A gas jetting structure comprising:
a first gas jetting pipe structured to jet ozone gas to a substrate;
second gas jetting pipes each of which is formed with second gas jetting holes for jetting unsaturated hydrocarbon gas to the substrate; and
a second gas buffer pipe structured to receive introduction of the unsaturated hydrocarbon gas and supply the unsaturated hydrocarbon gas to each of the second gas jetting pipes;
wherein the second gas jetting pipes are arranged perpendicular to a longitudinal direction of the second gas buffer pipe; and
wherein the second gas buffer pipe includes a buffer space structured to receive introduction of the unsaturated hydrocarbon gas and evenly distribute the unsaturated hydrocarbon gas to each of the second gas jetting pipes.

13. The gas jetting structure according to claim 10, wherein:
two adjacent ones of the first gas jetting pipes and the second gas jetting pipes have an axis-to-axis distance of 5 to 30 mm therebetween;
each of the first gas jetting holes and the second gas jetting holes has a diameter of 0.5 to 2 mm;
two adjacent ones of the first gas jetting holes have a center-to-center distance of 5 to 30 mm therebetween; and
two adjacent ones of the second gas jetting holes have a center-to-center distance of 5 to 30 mm therebetween.

14. A surface treatment method with the gas jetting structure according to claim 10, comprising:
supplying the ozone gas to the first gas jetting pipes; and
after the ozone gas reaches a predetermined flow rate, supplying the unsaturated hydrocarbon gas to the second gas jetting pipes.

15. The surface treatment method according to claim 14, comprising increasing a flow rate of the unsaturated hydrocarbon gas in a stepwise manner.

16. A surface treatment method with the gas jetting structure according to claim 11, comprising:
an operation of causing the first gas jetting pipes to jet the ozone gas from the first gas jetting holes to the substrate at a predetermined flow rate, while causing the second gas jetting pipes to jet the unsaturated hydrocarbon gas from the second gas jetting holes to the substrate at a flow rate that increases over time; and
an operation of causing the first gas jetting pipes to receive introduction of the unsaturated hydrocarbon gas from the first gas buffer pipe in place of the ozone gas, and jet the unsaturated hydrocarbon gas from the first gas jetting holes to the substrate at a flow rate that decreases over time, while causing the second gas jetting pipes to receive introduction of the ozone gas from the second gas buffer pipe in place of the unsaturated hydrocarbon gas, and jet the ozone gas from the second gas jetting holes to the substrate at a predetermined flow rate.

17. A surface treatment device comprising the gas jetting structure according to claim 10.

18. A surface treatment device comprising the gas jetting structure according to claim 12.
